(19) United States
(12) Patent Application Publication
(10) Pub. No.: US 2026/0286577 A1
(43) Pub. Date: Sep. 24, 2026

(54) RECYCLING SYSTEM OF FIBER BLEND PRODUCT

(71) Applicant: NAN YA PLASTICS CORPORATION, TAIPEI (TW)

(72) Inventors: CHING-YAO YUAN, TAIPEI (TW); CHUNG-YU CHEN, TAIPEI (TW); CHUNG-CHI SU, TAIPEI (TW)

(21) Appl. No.: 19/228,781

(22) Filed: Jun. 5, 2025

(30) Foreign Application Priority Data
Mar. 24, 2025 (TW) 114110902

(51) Int. Cl. D01G 11/00; D01G 5/00

(52) U.S. Cl. CPC D01G 11/00; D01G 5/00

(57) ABSTRACT

A recycling system of fiber blend products includes a chemical separation device and a physical separation device. The chemical separation device is configured to perform a hydrothermal degradation reaction on a fiber blend product that includes a first fiber and a second fiber. In the hydrothermal degradation reaction, the first fiber does not undergo any chemical changes, and the second fiber degrades. The physical separation device includes a water infiltration device and a pressing device. The water infiltration device is configured to wet the fiber blend product that has undergone the hydrothermal degradation reaction with water. The pressing device is configured to press the water-wetted fiber blend product, such that water inside the water-wetted fiber blend product penetrates outward and carries away degradation products of the second fiber through mechanical force.

### CROSS-REFERENCE TO RELATED PATENT APPLICATION

This application claims the benefit of priority to Taiwan Patent Application No. 114110902, filed on Mar. 24, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a recycling system of fiber products, and more particularly to a recycling system of fiber blend products, such as products made of a blend of a polyester fiber and a natural fiber like cotton or wool.

### BACKGROUND OF THE DISCLOSURE

Polyester/cotton blended fabrics are widely used in the fields of clothing and home textiles due to the durability of polyester and the comfort of cotton. While a large quantity of such products is discarded annually, only a small portion of the discarded products enters recycling systems.

The composition and structure of polyester/cotton blended fabrics are complex, causing high separation and processing costs. Moreover, the physical and chemical properties of polyester fibers are quite different from those of cotton fibers, making it difficult to physically separate the cotton fibers from the polyester fibers by a single treatment. Hence, there is a need for different treatments that cooperate with each other, which complicates the separation process. TWI845823B discloses a method of subjecting a blended fiber textile material to mechanical decomposition, an acid treatment, and an alkaline treatment in a sequence. The mechanical decomposition is used to break open the textile structure within the material. The acid treatment is used to adjust the degree of polymerization of cellulose and to dissolve and remove acid-soluble impurities. The alkaline treatment is used to remove non-cellulosic components and further modify the properties of the cellulose.

WO2019047174A1 discloses a method in which polyester/cotton blended fabrics are divided into fragments and dispersed in an aqueous solution system containing an organic acid catalyst to form a mixed system with a solid-to-liquid ratio of 1:30 to 200. The mixed system is then heated to a temperature of 110-180° C. This method requires a large volume of liquid, and the recovered polyester fibers still contain a small amount of cotton debris, resulting in poor purity.

### SUMMARY OF THE DISCLOSURE

In response to the above-referenced technical inadequacies, the present disclosure provides a recycling system of fiber blend products, which can separate each of a polyester fiber and a natural fiber like cotton or wool from a fiber blend product for high purity recycling.

In order to solve the above-mentioned problems, one of the technical aspects adopted by the present disclosure is to provide a recycling system of fiber blend products, which includes a chemical separation device and a physical separation device. The chemical separation device is configured to perform a hydrothermal degradation reaction on a fiber blend product that includes a first fiber and a second fiber different from the first fiber. In the hydrothermal degradation reaction, the first fiber does not undergo any chemical changes, and the second fiber degrades. The physical separation device includes a water infiltration device and a pressing device. The water infiltration device is operatively connected to the chemical separation device, and is configured to wet the fiber blend product, that has undergone the hydrothermal degradation reaction, with water. The pressing device is operatively connected to the water infiltration device, and is configured to press the water-wetted fiber blend product, such that water inside the water-wetted fiber blend product penetrates outward and carries away degradation products of the second fiber through mechanical force.

In one of the possible or preferred embodiments, the physical separation device includes a separator that is operatively connected to the pressing device, and is configured to retain the pressed fiber blend product and allow the water and the degradation products of the second fiber to pass there-through.

In one of the possible or preferred embodiments, the physical separation device includes a conveyor that is disposed between the water infiltration device and the separator to provide a conveying path from the separator back to the water infiltration device.

In one of the possible or preferred embodiments, the water infiltration device is in fluid communication with the separator via a filter to reuse the water that passes through the separator, and the filter is configured to remove the degradation products of the second fiber from the water that passes through the separator.

In one of the possible or preferred embodiments, the water infiltration device includes a feeder and a sprinkler disposed above the feeder. The sprinkler is configured to spray water to the fiber blend product that has undergone the hydrothermal degradation reaction. The feeder is configured to supply the water-wetted fiber blend product to the pressing device for squeezing.

In one of the possible or preferred embodiments, the pressing device includes at least one pressing roller assembly that includes two rollers being arranged opposite to each other and driven to rotate in opposite directions to squeeze the water-wetted fiber blend product.

In one of the possible or preferred embodiments, the at least one pressing roller assembly includes a first pressing roller assembly and a second pressing roller assembly being arranged in sequence.

In one of the possible or preferred embodiments, the chemical separation device includes a reactor that is configured to perform the hydrothermal degradation reaction in such a manner that a catalyst aqueous solution comes into contact with the fiber blend product.

In one of the possible or preferred embodiments, the chemical separation device includes a storage tank for storing the catalyst aqueous solution, and a spraying device is disposed in the reactor and is in fluid communication with the storage tank via a circulation pipeline.

In one of the possible or preferred embodiments, the circulation pipeline is configured in such a manner that the catalyst aqueous solution circulates between the reactor and the storage tank and is sprayed out by the spraying device to repeatedly contact the fiber blend product. Furthermore, a contact frequency of the catalyst aqueous solution with the fiber blend product is 3 to 4 times per minute, and the solid-to-liquid ratio of the fiber blend product to the catalyst aqueous solution is 1:5-10.

In conclusion, the recycling system of fiber blend products provided by the present disclosure can easily and physically separate cotton fibers from polyester fibers in fiber blend products, ensuring excellent separation efficiency even under the condition of a low solid-to-liquid ratio, by virtue of the chemical separation device configured to perform a hydrothermal degradation reaction on a fiber blend product, the water infiltration device of the physical separation device configured to wet the fiber blend product that has undergone the hydrothermal degradation reaction with water, and the pressing device configured to press the water-wetted fiber blend product. On this basis, the recovery purity of the polyester fibers can exceed 98%, and the recovery purity of the cotton fibers can exceed 99%.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a block diagram of a recycling system of fiber blend products of the present disclosure;

FIG. 2 is another block diagram of the recycling system of fiber blend products of the present disclosure;

FIG. 3 is a partial schematic view of a physical separation device of the recycling system of fiber blend products of the present disclosure;

FIG. 4 is a schematic view of a chemical separation device of the recycling system of fiber blend products of the present disclosure; and

FIG. 5 is a flowchart of a recycling method of fiber blend products of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

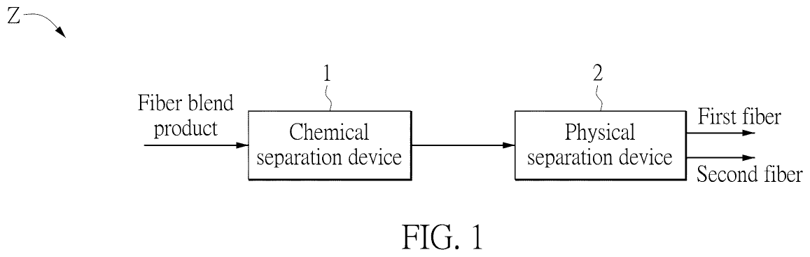

Referring to FIG. 1, a first embodiment of the present disclosure provides a recycling system Z of fiber blend products, which includes a chemical separation device 1 and a physical separation device 2. The chemical separation device 1 is configured to perform a hydrothermal degradation reaction on a fiber blend product. The fiber blend product can include a first fiber and a second fiber different from the first fiber. In the hydrothermal degradation reaction, the first fiber does not undergo any chemical changes, and the second fiber degrades. The physical separation device 2 is operatively connected to the chemical separation device 1. The physical separation device 2 is configured to press the fiber blend product that has undergone the hydrothermal degradation reaction under the action of water infiltration, utilizing mechanical force to allow water to penetrate out of the fiber blend product and carry away degradation products of the second fiber. Therefore, different fiber components can be separated from the fiber blend product to be recycled with high purity. If necessary, a fiber blend product to be treated can be divided into a number of fragments (i.e., small pieces) before undergoing the hydrothermal degradation reaction.

In the present embodiment, the first fiber of the fiber blend product is a polyester fiber, which does not undergo degradation in the hydrothermal degradation reaction. The second fiber of the fiber blend product is a cotton fiber, which degrades in the hydrothermal degradation reaction and separates from the polyester fiber in the form of degradation products. Examples of the polyester fiber include polyethylene terephthalate (PET), polypropylene terephthalate (PPT), polybutylene terephthalate (PBT), polycyclohexylenedimethylene terephthalate (PCT), and polyethylene naphthalate (PEN) fibers.

The above description is merely one possible embodiment and is not intended to limit the present disclosure. In certain embodiments, the first fiber of the fiber blend product is still a polyester fiber, but the second fiber of the fiber blend product can be a wool fiber or a nylon fiber.

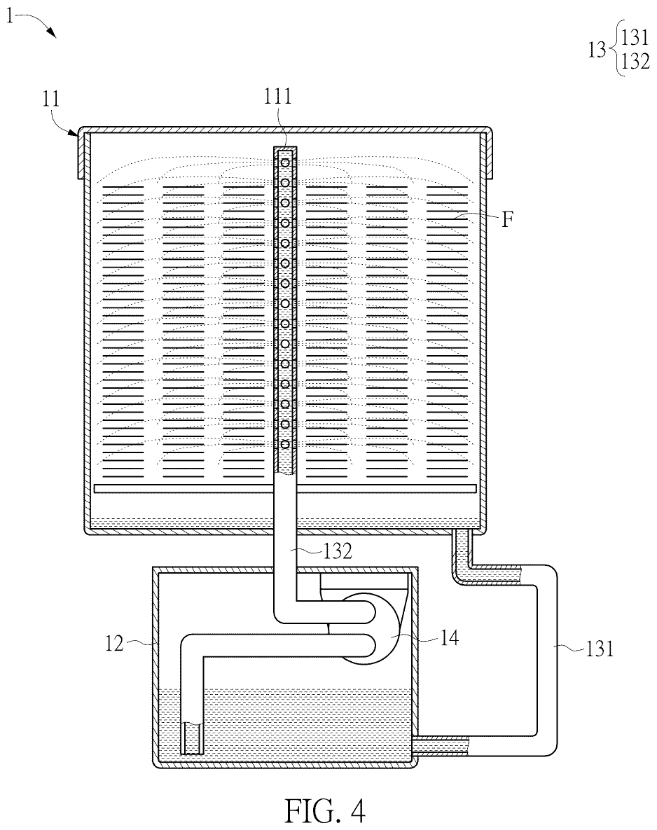

Reference is made to FIG. 4, the chemical separation device 1 mainly includes a reactor 11, in which a sealed environment with a high temperature and a high pressure can be formed. Specifically, the reactor 11 is configured to perform the hydrothermal degradation reaction in such a manner that a catalyst aqueous solution comes into contact with the fiber blend product. Said contact can be achieved by immersing the fiber blend product in the catalyst aqueous solution or by circulating the catalyst aqueous solution through the fiber blend product.

In the present embodiment, the hydrothermal degradation reaction can be carried out at a temperature from 130° C. to 160° C. The catalyst aqueous solution includes at least one catalyst and water. Based on a total weight of the catalyst aqueous solution being 100 wt %, an amount of the at least one catalyst can be from 0.1 wt % to 10 wt %, and preferably from 3 wt % to 5 wt %. The at least one catalyst suitable for use in the present disclosure can be an organic acid, an organic anhydride, a Lewis acid, or any combination thereof. It should be noted that an increase in the amount of the catalyst can accelerate the degradation rate of the second fiber in the fiber blend product, thereby shortening the reaction time, but results in higher costs.

Specific examples of the organic acid include methanesulfonic acid, oxalic acid, tartaric acid, citric acid, malic acid, formic acid, and acetic acid. The organic acid serving as the catalyst of the catalyst aqueous solution is preferably oxalic acid.

Specific examples of the organic anhydride include acetic anhydride, propionic anhydride, butyric anhydride, valeric anhydride, lauric anhydride, palmitic anhydride, stearic anhydride, malonic anhydride, succinic anhydride, glutaric anhydride, adipic anhydride, acrylic anhydride, cinnamic anhydride, phthalic anhydride, acetic benzoic anhydride, amino acid anhydrides, and derivatives thereof. The organic anhydride serving as the catalyst of the catalyst aqueous solution is preferably acetic anhydride.

Specific examples of the Lewis acid include boron trichloride, zinc chloride, ferric chloride, copper chloride, nickel nitrate, cobalt nitrate, and zinc tetrafluoroborate. The Lewis acid serving as the catalyst of the catalyst aqueous solution is preferably at least one of zinc chloride or ferric chloride.

In practice, the chemical separation device 1 can further include a storage tank 12 for storing the catalyst aqueous solution, and the storage tank 12 is configured to provide the catalyst aqueous solution into the reactor 11. In an embodiment in which the catalyst aqueous solution circulates through the fiber blend product, a spraying device 111 is disposed in the reactor 11 and in communication with the storage tank 12 via a circulation pipeline 13, and a circulation pump 14 is installed on the spraying device 111. Accordingly, the catalyst aqueous solution can repeatedly come into contact with the fiber blend product in a circulation and backflow manner. That is, the catalyst aqueous solution circulates between the reactor 11 and the storage tank 12 through the circulation pipeline 13, and is sprayed out by the spraying device 111 to repeatedly contact the fiber blend product under the action of the circulation pump 14.

More specifically, the catalyst aqueous solution is delivered by the circulation pump 14 to the storage tank 12 through an upstream section 131 of the circulation pipeline 13 from the bottom of the reactor 11. Afterward, the catalyst aqueous solution in the storage tank 12 is delivered by the circulation pump 14 to the spraying device 111 through a downstream section 132 of the circulation pipeline 13 for circulation and use. The entire process can be fully automated. When the hydrothermal degradation reaction is carried out under such operations, a contact frequency of the catalyst aqueous solution with the fiber blend product is 3 to 4 times per minute, and the solid-to-liquid ratio of the fiber blend product to the catalyst aqueous solution is 1:5-10. Therefore, in the chemical separation device 1, a reaction can be carried out at a lower solid-to-liquid ratio, thereby greatly reducing the amount of catalyst aqueous solution required and lowering costs. In addition, the chemical separation device 1 does not use any solvents other than water when performing the hydrothermal degradation reaction, so that it does not cause harm to the environment.

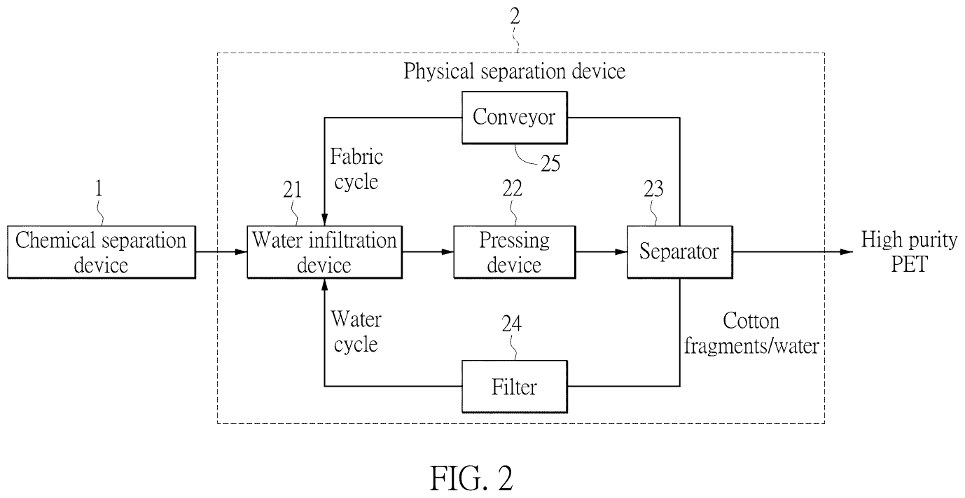

Reference is made to FIG. 2. The physical separation device 2 includes a water infiltration device 21 and a pressing device 22. The water infiltration device 21 is operatively connected to the chemical separation device 1. The water infiltration device 21 is configured to wet the fiber blend product that has undergone the hydrothermal degradation reaction with water. The pressing device 22 is operatively connected to the water infiltration device 21. The pressing device 22 is configured to press the water-wetted fiber blend product, such that water inside the water-wetted fiber blend product penetrates outward and carries away degradation products of the second fiber through mechanical force.

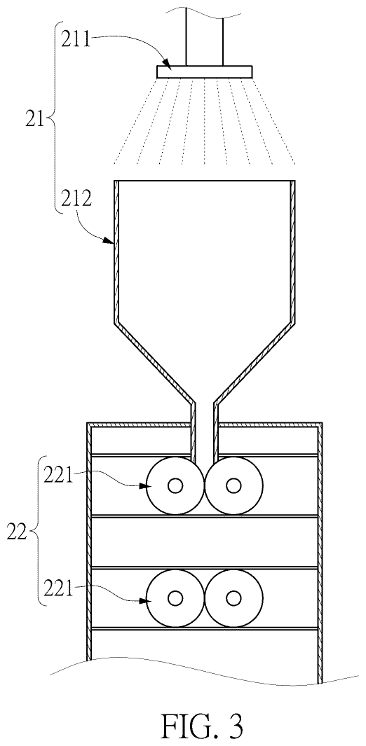

Reference is further made to FIG. 3. The water infiltration device 22 can include a sprinkler 211 and a feeder 212. The sprinkler 211 is disposed above the feeder 22. The sprinkler 211 is configured to spray water to the fiber blend product that has undergone the hydrothermal degradation reaction. The feeder 212 is configured to supply the water-wetted fiber blend product to the pressing device 22. The feeder 212 can be a hopper feeder, but is not limited thereto. Furthermore, the pressing device 22 can include at least one pressing roller assembly 221, in which two rollers are arranged opposite to each other and squeeze water from the water-wetted fiber blend product through relative rotation, thereby carrying away degradation products of the second fiber.

More specifically, the pressing roller assembly 221 can include two rollers that are arranged opposite to each other in a left-right direction, and the two rollers can be driven to rotate in opposite directions. Upon falling between the two rollers via the feeder 212, the water-wetted fiber blend product is subjected to squeezing. If necessary, the pressing device 22 can include a plurality of pressing roller assemblies to increase pressing efficiency. For example, the pressing device 22 can include an upper pressing roller assembly 221 and a lower pressing roller assembly 221 to perform two sequential pressing operations on the water-wetted fiber blend product, thereby squeezing out more degradation products of the second fiber.

Referring to FIG. 2 again, the physical separation device 2 can further include a separator 23 to facilitate the recovery of the first fiber from the fiber blend product. The separator 23 is operatively connected to the pressing device 22. The separator 23 is configured to retain the pressed fiber blend product and allow water and the degradation products of the second fiber to pass there-through. The separator 23 can be a mesh-type separator, but is not limited thereto. Furthermore, the physical separation device 2 can further include a filter 24. The filter 24 is configured to remove the degradation products of the second fiber from the water that passes through the separator 23, so as to reuse the water that passes through the separator.

In order to enhance the operability and practicality of the system, the physical separation device 2 can further include a conveyor 25. The conveyor 25 is disposed between the water infiltration device 21 and the separator 23 to provide a conveying path (i.e., a fabric circulation path) from the separator 23 back to the water infiltration device 21. The conveyor 25 may include one or more belt conveyors, but is not limited thereto. Accordingly, the fiber blend product that has undergone the hydrothermal degradation reaction can be repeatedly wetted with water and subjected to squeezing at least once, thereby squeezing out more degradation products of the second fiber.

### Second Embodiment

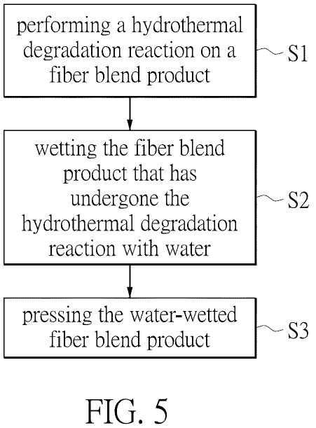

Referring to FIG. 5, a second embodiment of the present disclosure provides a recycling method of fiber blend products, which includes: step S1, performing a hydrothermal degradation reaction on a fiber blend product; step S2, wetting the fiber blend product that has undergone the hydrothermal degradation reaction with water; and step S3, pressing the water-wetted fiber blend product. The recycling method of the present disclosure can be implemented by the system described in the first embodiment, so as to realize separation and recycling of different fiber components (such as polyester and cotton fibers) in fiber blend products.

In step S1, the hydrothermal degradation reaction is performed in such a manner that a catalyst aqueous solution comes into contact with the fiber blend product. Said contact can be achieved by immersing the fiber blend product in the catalyst aqueous solution or by circulating the catalyst aqueous solution through the fiber blend product. In the hydrothermal degradation reaction, a first fiber of the fiber blend product does not undergo degradation, and a second fiber of the fiber blend product degrades and separates from the first fiber in the form of degradation products.

In an embodiment in which the first fiber is a polyester fiber and the second fiber is a cotton fiber, the hydrothermal degradation reaction can be carried out at a temperature from 130° C. to 160° C. In an embodiment in which the catalyst aqueous solution circulates through the fiber blend product, the catalyst aqueous solution can repeatedly come into contact with the fiber blend product. Furthermore, a contact frequency of the catalyst aqueous solution with the fiber blend product is 3 to 4 times per minute, and the solid-to-liquid ratio of the fiber blend product to the catalyst aqueous solution is 1:5-10.

In step S2, the fiber blend product that has undergone the hydrothermal degradation reaction can absorb water and become wetted when water is sprayed thereon. In step S3, water can be squeezed out from the water-wetted fiber blend product by roller rolling, thereby carrying away degradation products of the second fiber.

The related technical features mentioned in the first embodiment are still valid in the present embodiment, and will not be repeated herein for the sake of brevity. Similarly, the related technical features mentioned in the present embodiment can be applied to the first embodiment.

### Beneficial Effects of the Embodiments

In conclusion, the recycling system of fiber blend products provided by the present disclosure can easily and physically separate cotton fibers from polyester fibers in fiber blend products, ensuring excellent separation efficiency even under the condition of a low solid-to-liquid ratio, by virtue of the chemical separation device configured to perform a hydrothermal degradation reaction on a fiber blend product, the water infiltration device of the physical separation device configured to wet the fiber blend product that has undergone the hydrothermal degradation reaction with water, and the pressing device configured to press the water-wetted fiber blend product. On this basis, the recovery purity of the polyester fibers can exceed 98%, and the recovery purity of the cotton fibers can exceed 99%.

In the Comparative Example, in which a PET/cotton blended fiber product was treated only with the chemical separation device at a solid-to-liquid ratio of 1:10, the recovery purity of PET fibers was 85.3%, and the recovery purity of cotton fibers was 98.5%. In contrast, in Example 1, in which a PET/cotton blended fiber product was treated with the chemical separation device at a solid-to-liquid ratio of 1:5 followed by the physical separation device, the recovery purity of PET fibers was 98.2%, and the recovery purity of cotton fibers was 99.5%. In Example 2, in which a PET/cotton blended fiber product was treated with the chemical separation device at a solid-to-liquid ratio of 1:8 followed by the physical separation device, the recovery purity of PET fibers was 98.6%, and the recovery purity of cotton fibers was 99.8%. In Example 3, in which the PET/cotton blended fiber product was treated with the chemical separation device at a solid-to-liquid ratio of 1:10 followed by the physical separation device, the recovery purity of PET fibers was 98.8%, and the recovery purity of cotton fibers was 99.8%.

Furthermore, the recycling system of the fiber blend products of the present disclosure can realize the recycling of fiber resources, provides substantial economic benefits, and meets the requirements of industrial production.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A recycling system of fiber blend products, comprising:
a chemical separation device configured to perform a hydrothermal degradation reaction on a fiber blend product that includes a first fiber and a second fiber different from the first fiber, wherein, in the hydrothermal degradation reaction, the first fiber does not undergo any chemical changes, and the second fiber degrades; and
a physical separation device including a water infiltration device and a pressing device;
wherein the water infiltration device is operatively connected to the chemical separation device, and is configured to wet the fiber blend product that has undergone the hydrothermal degradation reaction with water;
wherein the pressing device is operatively connected to the water infiltration device, and is configured to press the water-wetted fiber blend product, such that water inside the water-wetted fiber blend product penetrates outward and carries away degradation products of the second fiber through mechanical force.

2. The recycling system according to claim 1, wherein the physical separation device includes a separator that is operatively connected to the pressing device, and is configured to retain the pressed fiber blend product and allow the water and the degradation products of the second fiber to pass there-through.

3. The recycling system according to claim 2, wherein the physical separation device includes a conveyor that is disposed between the water infiltration device and the separator to provide a conveying path from the separator back to the water infiltration device.

4. The recycling system according to claim 3, wherein the water infiltration device is in fluid communication with the separator via a filter to reuse the water that passes through the separator, and the filter is configured to remove the degradation products of the second fiber from the water that passes through the separator.

5. The recycling system according to claim 1, wherein the pressing device includes at least one pressing roller assembly that includes two rollers being arranged opposite to each other and driven to rotate in opposite directions to squeeze the water-wetted fiber blend product.

6. The recycling system according to claim 1, wherein the water infiltration device includes a feeder and a sprinkler disposed above the feeder, the sprinkler is configured to spray water to the fiber blend product that has undergone the hydrothermal degradation reaction, and the feeder is configured to supply the water-wetted fiber blend product to the pressing device for squeezing.

7. The recycling system according to claim 6, wherein the pressing device includes at least one pressing roller assembly that includes two rollers being arranged opposite to each other and driven to rotate in opposite directions to squeeze the water-wetted fiber blend product.

8. The recycling system according to claim 7, wherein the at least one pressing roller assembly includes a first pressing roller assembly and a second pressing roller assembly being arranged in sequence.

9. The recycling system according to claim 1, wherein the chemical separation device includes a reactor that is configured to perform the hydrothermal degradation reaction in such a manner that a catalyst aqueous solution comes into contact with the fiber blend product.

10. The recycling system according to claim 9, wherein the chemical separation device includes a storage tank for storing the catalyst aqueous solution, and a spraying device is disposed in the reactor and is in fluid communication with the storage tank via a circulation pipeline.

11. The recycling system according to claim 10, wherein the circulation pipeline is configured in such a manner that the catalyst aqueous solution circulates between the reactor and the storage tank and is sprayed out by the spraying device to repeatedly contact the fiber blend product; and wherein a contact frequency of the catalyst aqueous solution with the fiber blend product is 3 to 4 times per minute, and the solid-to-liquid ratio of the fiber blend product to the catalyst aqueous solution is 1:5-10.
